(19) United States
(12) Patent Application Publication
(10) Pub. No.: US 2026/0011267 A1
(43) Pub. Date: Jan. 8, 2026

(54) Reconfigurable Isometric-design Sticker Toy

(71) Applicant: Dwayne Walker, Stone Mountain, GA (US)

(72) Inventor: Dwayne Walker, Stone Mountain, GA (US)

(21) Appl. No.: 19/077,051

(22) Filed: Mar. 12, 2025

Related U.S. Application Data
(60) Provisional application No. 63/639,804, filed on Apr. 29, 2024.

(51) Int. Cl. G09B 25/08; B42D 1/00; G09F 3/02

(52) U.S. Cl. CPC G09B 25/08; B42D 1/00; G09F 3/02; G09F 2003/0226

(57) ABSTRACT

A reconfigurable, isometric-design, sticker toy (RIDST) is disclosed. The RIDST is comprised of a plurality of removable stickers, a transparent transfer sheet, a base sheet, and a sticker storage booklet. Each removable sticker is configured in an isometric view and when affixed to the base with other removable stickers a planar, three-dimensional scene is generated. An object of the RIDST is to a means for users, from children to adults, to use stickers to create and change scenes in an isometric room or landscape quickly and easily. Other details regarding this disclosure are discussed further in this specification.

### FIELD OF THE INVENTION

The present invention generally relates to stickers. More specifically, it relates to a system and method for generating 3D scenes using stickers.

### BACKGROUND

Stickers have a rich and diverse history that spans millennia, with their origins rooted in the early practices of labeling and marking objects for identification and decoration. In ancient civilizations like Egypt and Mesopotamia, clay tokens were impressed with symbols to denote ownership or contents of containers, serving a function akin to modern-day stickers. Similarly, the ancient Greeks and Romans used wax seals and pottery markings to signify ownership or quality. The evolution of stickers took a significant leap forward with the development of adhesive materials. In the 18th century, the invention of gummed paper by British stationer Sir Rowland Hill revolutionized the concept of sticking notes and labels onto surfaces. This adhesive innovation laid the groundwork for the modern sticker. The 19th century witnessed a surge in sticker production thanks to advancements in printing technology. The lithographic process, which allowed for mass production of colorful and detailed images, paved the way for the commercialization of stickers. Initially used for product labeling and packaging, stickers quickly found their way into various industries, including food and beverage, cosmetics, and transportation.

By the turn of the 20th century, stickers had become ubiquitous. They were employed for advertising purposes, often adorning everything from fruit crates and cigar boxes to railway cars and storefront windows. Companies recognized the power of stickers as a cost-effective means of brand promotion and product recognition. The early 20th century also saw stickers gain traction as a form of personal expression and political activism. During World War I, patriotic stickers adorned vehicles and windows, expressing solidarity with the war effort. In the following decades, stickers became a popular medium for promoting social causes, political candidates, and grassroots movements. The post-war era witnessed the rise of pop culture icons and brands, further propelling the sticker phenomenon. Cartoons, comic book characters, and advertising mascots became popular motifs for stickers, appealing to a wide audience, particularly children and teenagers. Stickers evolved from mere functional labels to collectible items and cherished keepsakes. The sticker industry has been creating new forms of stickers. United States Patent No. US20090317774A1 disclosed a method and apparatus for creating personalized art, United States Patent No. US20050232958A1 disclosed a temporary tattoo kit, U.S. Pat. No. 4,328,051A disclosed a system for transferring images, United States Patent No. US20180117954A1 disclosed a temporary tattoo label and system, United States Patent No. US20050230963A1 disclosed a sticker book with stickers employed on a book cover, U.S. Pat. No. 3,925,585A disclosed a sticker system, United States Patent No. DE4431748A1 disclosed a method of providing pre-prepared adhesive labels with printed markings on adhesive side. While stickers continue to evolve, what is needed is a set of stickers with base that allow users to generate three-dimensional scenes.

The realm of adhesives has witnessed a plethora of utilitarian and decorative applications, yet a void persists for a product that transcends conventional limitations to engage a broader demographic spanning from children to adult hobbyists and educational professionals. Existing adhesive decorative solutions typically afford minimal interactive or educational utility. The present invention, a

Reconfigurable Isometric-design Sticker Toy (RIDST), emerges as a response to an identified need within the market for a multifaceted, educational, and creative apparatus. It serves to bridge the gap between static artistic expressions and dynamic educational platforms, delivering a multifunctional tool adept at enhancing creative exploration and facilitating developmental progress in a variety of settings.

### SUMMARY OF THE INVENTION

The device herein disclosed and described provides a solution to the shortcomings in the prior art through the disclosure of a system and method for generating three dimensional (3D) scenes using stickers. An object of the RIDST is to a means for users, of all ages, to use stickers to create and change scenes in a room or landscape quickly and easily and without an understanding of foreshortening or dimensionality.

Another object of the RIDST is to allow users to position removable stickers on a base with precision. The removable stickers are configured on a transparent transfer sheet that allow users to first position stickers at a specific location of the base before they are affixed—a preview of sorts.

Another object of the RIDST is to provide users with a plurality of objects as removable stickers—such as characters, furniture and scenes. Multiple removable stickers can be combined and stacked upon one another to create a combined, 3D scene.

Another object of the RIDST is to allow users to reuse the removable stickers. Each removable sticker can be peeled off the base sheet and stored on the transfer sheet and can be reused for another art project.

Another object of the RIDST is to allow users to store removable stickers and base sheet when not in use. The system includes a sticker storage booklet that allows it to remain clean and organized.

It is briefly noted that upon a reading this disclosure, those skilled in art will recognize various means for carrying out these intended features of the invention. As such it is to be understood that other methods, applications and systems adapted to the task may be configured to carry out these features and are therefore considered to be within the scope and intent of the present invention, and are anticipated. With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention. As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present.

By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements. The objects features, and advantages of the present invention, as well as the advantages thereof over existing prior art, which will become apparent from the description to follow, are accomplished by the improvements described in this specification and hereinafter described in the following detailed description which fully discloses the invention, but should not be considered as placing limitations thereon.

The invention detailed herein, characterized by its isometric configuration and reusability, is poised to capture the interest of a diverse consumer spectrum. The utility of the RIDST extends beyond mere entertainment, positioning itself as a valuable asset for intricate model construction for adult enthusiasts and as a pedagogical aid aligning with scholastic directives. The provision for personalization and adaptation as a home decor element, coupled with its integration into literary media, accentuates the invention's commercial prospects. The RIDST distinguishes itself as an innovative product adept at converging traditional recreational applications with expansive educational and decorative utilities, indicating substantial market viability.

### BRIEF DESCRIPTION OF THE FIGURES

The accompanying drawings, which are incorporated herein and form a part of the specification, illustrate some, but not the only or exclusive, examples of embodiments and/or features.

FIG. 1 shows a perspective view of the RIDST base sheet.

FIG. 2 shows a perspective view of the RIDST with transfer sheet.

FIG. 3 shows a perspective view of the RIDST with removable sticker.

FIG. 4 shows a perspective view of the RIDST with removable sticker affixed to base sheet.

FIG. 5 shows the method of the RIDST with removable stickers stacked on base sheet.

FIG. 6 shows a completed scene of the RIDST.

Other aspects of the present invention shall be more readily understood when considered in conjunction with the accompanying drawings, and the following detailed description, neither of which should be considered limiting.

### DETAILED DESCRIPTION OF FIGURES

In this description, the directional prepositions of up, upwardly, down, downwardly, front, back, top, upper, bottom, lower, left, right and other such terms refer to the device as it is oriented and appears in the drawings and are used for convenience only; they are not intended to be limiting or to imply that the device has to be used or positioned in any particular orientation. Conventional components of the invention are elements that are well-known in the prior art and will not be discussed in detail for this disclosure.

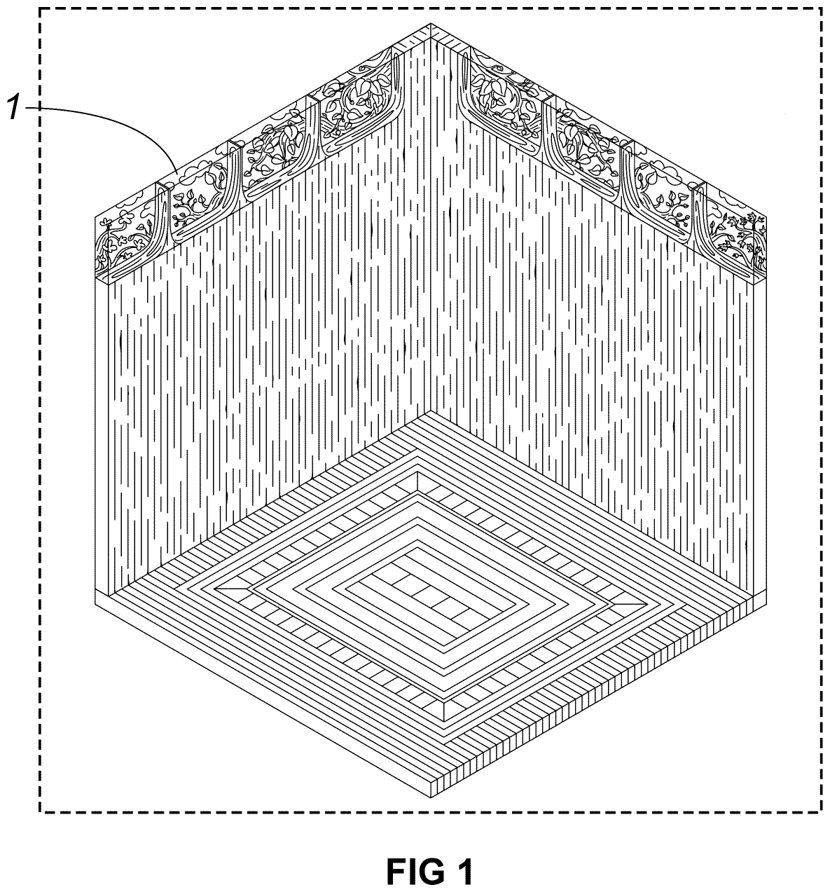

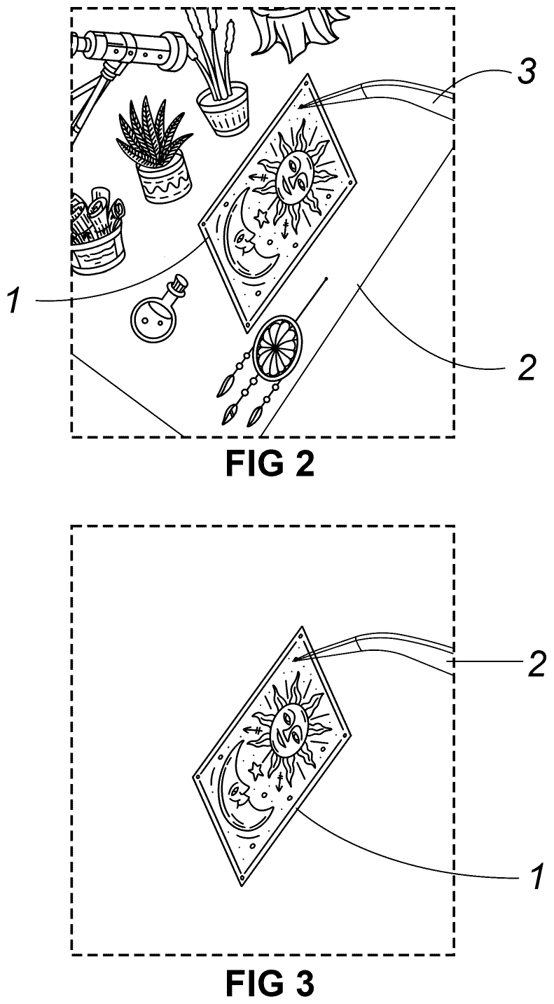

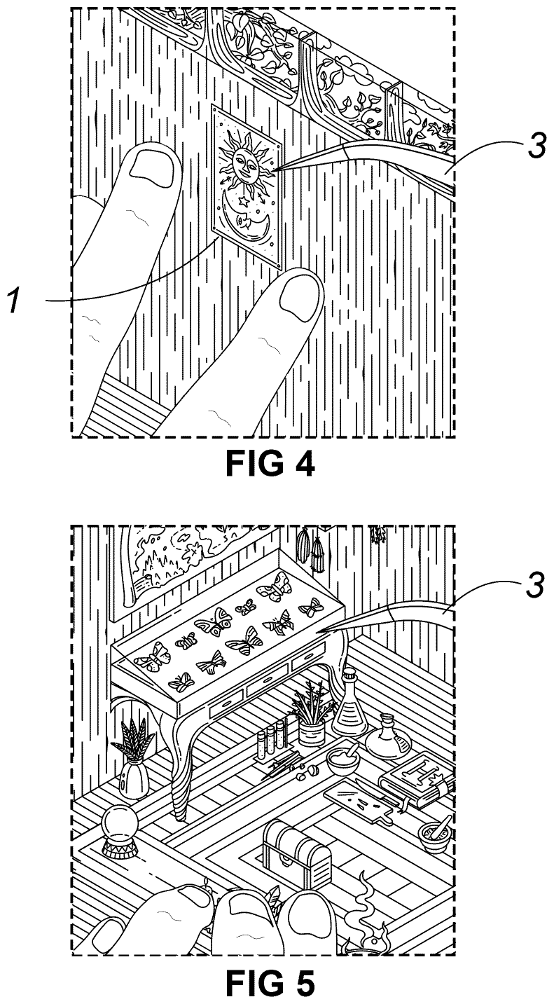

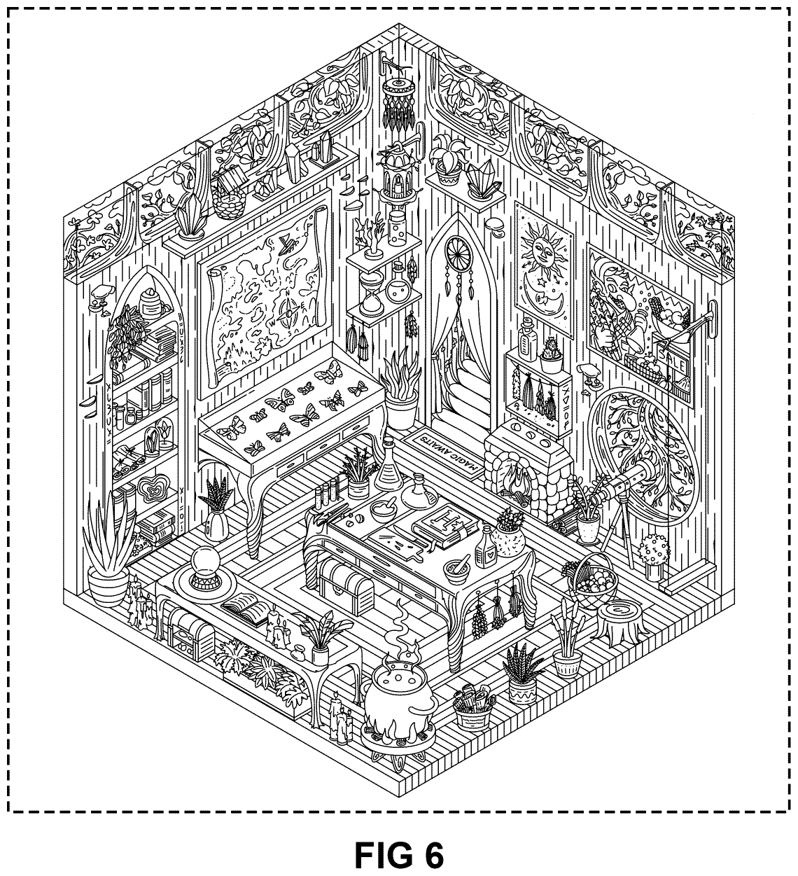

FIG. 1 showing an isometric-design base sheet of the RIDST without removable stickers attached. FIG. 2 showing a preferred embodiment of the RIDST comprised of a removable sticker 1 and transparent transfer sheet 2 being removed by tweezers 3. The planar, removable sticker 1 and transparent transfer sheet 2 being made of a thin, flexible material including but not limited to: vinyl, acetate, plastic, rubber, paper and the like. Said removable sticker 1 being constructed into a myriad of shapes, characters, furniture, background scenes in an isometric view. FIG. 3 showing the removal of removable sticker 1 from transparent transfer sheet 2. FIG. 4 showing removable sticker 1 being removably affixed to the base sheet. FIG. 5 shows the removable stickers stacked on the base sheet. FIG. 6 shows a completed scene of the RIDST. Other embodiments of the RIDST having removable stickers that have internal moving parts and extended relief patterns thereon. The method of the RIDST includes the following steps: unpacking the base sheet and sticker set from the packaging; laying the base sheet on a flat surface; selecting a sticker from the collection; laying the transfer sheet over the base sheet and moving it around until a position is selected; peeling the chosen sticker from the transfer sheet; positioning the removable sticker on the base sheet according to the desired location; pressing down on the removable sticker to secure it in place; repeating the first seven steps to adjust or layer additional removable stickers to enhance the scene; changing the scene by peeling off removable stickers and repositioning them or adding new ones; when finished playing, removing removable stickers and returning them to the storage booklet; cleaning the base sheet if necessary; and storing the base sheet and removable stickers back in the storage booklet.

It is additionally noted and anticipated that although the device is shown in its most simple form, various components and aspects of the device may be differently shaped or slightly modified when forming the invention herein. As such those skilled in the art will appreciate the descriptions and depictions set forth in this disclosure or merely meant to portray examples of preferred modes within the overall scope and intent of the invention, and are not to be considered limiting in any manner. While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the scope of the invention.

The various embodiments of the RIDST delineated herein are meticulously crafted, cognizant of their broad commercial and educational applications. For the adult hobbyist sector, the kits are engineered with a complexity that caters to the nuanced demands of model fabrication and miniature artistry. The customization service broadens the invention's appeal, facilitating personal adaptations that resonate with individual users' preferences, emblematic of memory preservation and personalized aesthetics. The educational potential is notably enhanced through strategic academic collaborations, rendering the RIDST a conduit for visualizing and manipulating geometrical and spatial concepts. Moreover, the potential of the RIDST to function as an immersive pedagogical tool within museums and cultural institutions is anticipated, enabling an enriched, interactive patron experience. Therapeutic modalities are similarly contemplated, with the RIDST designed to advance fine motor proficiency and cognitive planning. The envisaged utility of the RIDST as an inventive art medium, a novel tool for interior design, and as an entertainment feature at diverse events underscores its multifaceted nature and the expected demand across these verticals. Collectively, these attributes herald the RIDST's aptitude for widespread adoption in varied commercial domains.

The present invention, while encompassing the current embodiment of the Reconfigurable Isometric-design Sticker Toy (RIDST), is not limited thereto. It is envisaged that the scope of this invention will extend and evolve through subsequent developments, driven by technological advancements and market needs.
1. Sticker Kit Marketplace: It is anticipated that the RIDST will catalyze the establishment of a creative marketplace. This platform will empower independent artists and designers to contribute their unique visions to the RIDST ecosystem, thereby enriching the variety and cultural breadth of the sticker sets available, enhancing user engagement, and fostering community growth within the brand's sphere.
2. Customizable RIDST Stickers through AI: Emerging artificial intelligence technologies will enable a customizable interface for RIDST stickers. This interface will harness user inputs to generate bespoke sticker designs, which can be realized through home printing solutions or a dedicated production service, thereby augmenting the personal connection between the user and the product.
3. Educational Expansion: There is a clear trajectory toward the integration of the RIDST into educational frameworks. Collaborative ventures with educational specialists are projected to produce kits that align with scholastic curricula, providing tangible benefits in pedagogical contexts, particularly in the areas of spatial reasoning, cultural education, and the visualization of abstract concepts.
4. Augmented Reality Storytelling: The implementation of augmented reality (AR) into the RIDST is projected, whereby specific configurations of stickers will interface with AR technology to unlock immersive narrative experiences, interactive educational content, and virtual exploration, thus enriching the user's interactive experience.
5. Environmental Focus: The RIDST will incorporate an eco-conscious dimension, with the introduction of stickers produced from environmentally friendly materials. The concurrent establishment of a recycling initiative for sticker products underlines a commitment to sustainability, aligning with global environmental stewardship trends.
6. Therapeutic and Wellness Oriented Kits: The RIDST is envisioned as a medium for therapeutic and wellness applications, with specially curated kits to be used in activities aimed at promoting mental well-being, mindfulness, and therapeutic expression. This dimension of the RIDST will be developed in consultation with mental health practitioners.
7. Collaborative Integration with Other Toys: It is anticipated that the RIDST will undergo cross-brand integration, forming alliances with established toy lines to create hybrid playsets. These integrations are intended to synergize with various play modalities, thus enhancing cognitive and creative play through multi-dimensional interaction.
8. Subscription Model Evolution: A subscription-based framework for the RIDST is projected to maintain consumer engagement and ensure the continuity of innovation. This model will provide a consistent stream of new sticker sets, alongside exclusive access to content, community events, and advanced product features, thereby fostering a robust and dynamic user experience.
9. Digital and Mobile Application Expansion: It is further anticipated that the RIDST concept will extend into digital environments, including but not limited to mobile applications, web-based platforms, and virtual or augmented reality systems. In such embodiments, the removable stickers and isometric base sheets are implemented as virtual objects displayed on a computing device, allowing users to select, reposition, and reconfigure digital stickers within an isometric scene. These digital stickers may be animated, interactive, or linked with sound, narrative content, or gamified features. The virtual RIDST may also support multi-user collaboration, enabling multiple participants to co-create isometric scenes in real time across networked devices. Such mobile and digital embodiments maintain the core inventive concept of reconfigurable isometric sticker-based scene generation while expanding its accessibility, interactivity, and creative potential in both entertainment and educational contexts.
   These future developments are intended to be within the scope of the present invention, as they share the foundational principles laid out herein and seek to further the invention's application in ways that are currently foreseeable.

1. A reconfigurable interactive design sticker system (RIDST), comprising:
a. A removable sticker constructed from a thin, flexible material selected from the group consisting of vinyl, acetate, plastic, rubber, paper, and similar materials;
b. A transparent transfer sheet for facilitating the removal of the removable sticker;
c. Tweezers for aiding in the removal of the removable sticker from the transparent transfer sheet;
d. Said removable sticker being configured into various shapes, characters, furniture, and background scenes in an isometric view.

2. The system of claim 1, wherein the removable stickers can further comprise internal moving parts and extended relief patterns.

3. The system of claim 1, wherein the transparent transfer sheet is transparent to aid in precise placement of the removable sticker onto a base sheet.

4. The system of claim 1, further comprising a base sheet onto which the removable sticker is removably affixed.

5. The system of claim 4, wherein the base sheet is planar and is placed on a flat surface during use.

6. The system of claim 1, further comprising a storage booklet for organizing and storing the removable stickers and base sheet when not in use.

7. A method for using a reconfigurable interactive design sticker system (RIDST), comprising the steps of:
a. Unpacking a base sheet and sticker set from packaging;
b. Selecting a removable sticker from the collection;
c. Laying the transparent transfer sheet over the base sheet and positioning it until a desired location is selected;
d. Peeling the chosen removable sticker from the transparent transfer sheet;
e. Positioning the removable sticker on the base sheet according to the desired location;
f. Pressing down on the removable sticker to secure it in place;
g. Repeating steps e through g to adjust or layer additional removable stickers to enhance the scene;
h. Changing the scene by peeling off removable stickers and repositioning them or adding new ones;
i. When finished, if preferred, removing removable stickers and storing the base sheet and stickers in the storage booklet;
